(19) United States
(12) Patent Application Publication
(10) Pub. No.: US 2026/0027867 A1
(43) Pub. Date: Jan. 29, 2026

(54) PREDICTIVE AIR CONDITIONING CONTROL SYSTEM AND METHOD

(71) Applicants: HYUNDAI MOTOR COMPANY, Seoul (KR); KIA CORPORATION, Seoul (KR)

(72) Inventors: Nam-Seok Yun, Hwaseong-si (KR); Bo-Hyeon Ryu, Hwaseong-si (KR)

(73) Assignees: HYUNDAI MOTOR COMPANY, Seoul (KR); KIA CORPORATION, Seoul (KR)

(21) Appl. No.: 19/001,866

(22) Filed: Dec. 26, 2024

(30) Foreign Application Priority Data
Jul. 29, 2024 (KR) 10-2024-0100296

(51) Int. Cl. B60H 1/00

(52) U.S. Cl. CPC B60H 1/0073; B60H 1/00742

(57) ABSTRACT

A predictive air conditioning control system for a bus includes a passenger heat calculation part calculating heat acquired from passengers at each bus stop on a bus route, an outside air heat calculation part calculating heat acquired from an inflow of outside air at each bus stop, a heat acquisition constant model generation part generating a heat acquisition constant model for the bus route by reflecting the heat acquired from passengers and the heat acquired from outside air, and a predictive air conditioning controller generating a model-based predictive control value applied with the heat acquisition constant model and controlling an air conditioner of the bus depending on the model-based predictive control value.

### CROSS-REFERENCE TO RELATED APPLICATION

This application claims priority to Korean Patent Application No. 10-2024-0100296, filed on Jul. 29, 2024 which is incorporated herein by reference in its entirety.

### BACKGROUND OF THE DISCLOSURE

### Field of the Disclosure

The present disclosure relates to a system and method for predicting and

controlling air conditioning in the interior of a vehicle, such as a bus.

### Description of Related Art

Currently, air conditioning systems of city buses are a passive control system that are controlled directly by the driver, which causes passengers to complain about the comfort of the air conditioning. Since the driver has to respond to passengers' complaints by appropriately operating the air conditioning system, the driver cannot concentrate on driving accordingly, which may increase fatigue and impede safe driving.

To solve these problems, the prior art technology is disclosed in Korean Patent Publication No. 10-2023-0010855, in which efficient and active air conditioning control is performed using real-time passenger information in the bus, thereby providing a more comfortable environment for passengers and improving vehicle electric energy consumption.

Referring to FIG. 1, big data analytics collects the number of passengers, passengers' body temperatures, passengers' locations in the vehicle, outside temperature/humidity (S1). An external server processes the big data, estimates the bus interior temperature, determines the default temperature, and determines the opening and closing of a duct by route and time (S2). A controller executes the default temperature and duct opening and closing by the route and time and transmits big data in real-time (S3). The external server receives the big data and sends temperature and duct opening and closing correction commands when the difference between the big data default temperature and real-time big data occurs (S4). The controller performs target temperature correction and duct opening and closing correction (S5).

However, passenger counting using card tags is inaccurate due to problems such as untagging and cash use, and it is not possible to check whether passengers have gotten off the bus. In addition, the proposed method of measuring passengers' body temperatures has many practical barriers in the busy situation of boarding a city bus, and it is unclear how the measured body temperature is used in determining the air conditioning set temperature. In the case of passengers' locations detection, the accuracy of passengers' smartphone GPSs is low (GPSs are known to have a distance tolerance of more than 5 meters), and the sensitivity of electronically controlled AIR Suspension (ECAS) is too low to sense the exact locations of passengers in vehicles such as an 11-meter-long bus space for duct opening and closing, making its use questionable.

Additionally, it is not specified in the prior art how and in what way the external server receives and processes the five types of big data to estimate the interior temperature of the city bus, and it is not also specified how to process and determine the default set temperature based on the estimated interior temperature of the bus.

Furthermore, it is not specified what data the air conditioning controller uses to execute the default set temperature and duct opening and closing. For example, it is unknown if the controller executes the default set temperature and duct opening and closing based on yesterday's data, data from a week ago, or an average of data over a period of time. How big data is utilized has a significant impact on the outcome of the air conditioning control.

In addition, it is not specified what algorithm is used to calibrate the set temperature by comparing existing big data and real-time big data.

The foregoing background description is intended to provide an understanding of the background of the disclosure, and may include matters that are not the related art technology already known to one of ordinary skill in the art to which this technology belongs.

### SUMMARY OF THE DISCLOSURE

The present disclosure is intended to provide a predictive air conditioning control system and method that enables more specific and effective data collection and air conditioning prediction. While examples disclosed herein may refer to a predictive air conditioning control system and method for a bus, the disclosed predictive air conditioning system and method may be implemented in other vehicles as well.

An aspect of the present disclosure provides a predictive air conditioning control system for a bus, the predictive air conditioning control system including: a passenger heat calculation part calculating heat acquired from passengers within the bus; an outside air heat calculation part calculating heat acquired from an inflow of outside air; a heat acquisition constant model generation part generating a heat acquisition constant model for a bus route by reflecting the heat acquired from passengers and the heat acquired from the outside air; and a predictive air conditioning controller generating a model-based predictive control value applied with the heat acquisition constant model and controlling an air conditioner of the bus depending on the model-based predictive control value.

The passenger heat calculation part may be configured to calculate the heat acquired from passengers by multiplying the number of passengers counted by a camera mounted on the bus at each bus stop and a heat generated from each passenger.

The passenger heat calculation part may be configured to calculate the heat generated from each passenger by receiving clothing information about passengers' clothing detected by the camera and differentially applying the heat generated from each passenger depending on the clothing information.

The outside air heat calculation part may be configured to calculate the heat acquired from outside air by using a temperature difference between an inside air and an outside air and a humidity difference between the inside air and outside air sensed by a temperature/humidity sensor mounted on the bus.

The outside air heat calculation part may calculate the door opening time of the bus from a controller area network (CAN) signal of the bus.

The heat acquisition constant model generation part may be configured to generate the heat acquisition constant model by reflecting the heat generated from each passenger and multiplying the heat acquired from the inflow of outside air by the door opening time.

The system may further include a traveling information recorder configured to receive the current date and time during traveling of the bus by the CAN signal of the bus, and record changes in the heat acquired from the passengers and the heat acquired from the inflow of the outside air during traveling.

The traveling information recorder may be configured to receive location information of the bus during traveling by a global positioning system (GPS) mounted on the bus and record the changes in the heat acquired from the passengers depending on the location of the bus and in the heat acquired from the inflow of the outside air.

The system may further include a predictive control determination part configured to calculate an estimated time of arrival at each bus stop from bus arrival traffic information of the bus via an open application programming interface (API) and determine a control time of the air conditioner with the model-based predictive control value in consideration of the estimated time of arrival at each bus stop.

The heat acquisition constant model generation part may be configured to generate the heat acquisition constant model at a date, time and location during traveling of the bus by the traveling information recorder.

The predictive air conditioning controller may be configured to control the air conditioner at a certain time prior to the arrival time of the bus at the specific bus stop depending on the model-based predictive control value of the specific bus stop.

The heat acquisition constant model generation part may be configured to receive a heat acquisition constant model from other buses on the bus route via inter-bus data communication.

Another aspect of the present disclosure provides a predictive air conditioning control method including: a passenger heat calculation step of calculating heat acquired from passengers on a bus at each bus stop on a bus route; an outside air heat calculation step of calculating heat acquired from an inflow of outside air at each bus stop; a heat acquisition constant model generation step of generating a heat acquisition constant model for the bus route by reflecting the heat generated from each passenger and the heat acquired from the inflow of outside air; and a model-based predictive control step of generating a model-based predictive control value applied with the heat acquisition constant model and controlling an air conditioner depending on the model-based predictive control value.

The passenger heat calculation step may include calculating the heat generated from each passenger by multiplying a number of passengers counted by a camera mounted on the bus at each bus stop and a heat generated from each passenger.

The outside air heat calculation step may include calculating a door opening time of the bus from a controller area network (CAN) signal of the bus, and the heat acquisition constant model generation step may include generating the heat acquisition constant model by reflecting the heat generated from each passenger and multiplying the heat acquired from the inflow of outside air by the door opening time.

The heat acquisition constant model generation step may include generating the heat acquisition constant model depending on the current date and time during traveling of the bus, received by the CAN signal of the bus, and location information of the bus during traveling, received by a global positioning system (GPS) mounted on the bus.

The model-based predictive control step may include calculating an estimated time of arrival at each bus stop from bus arrival traffic information of the bus via an open application programming interface (API) and determining a time to control the air conditioner with the model-based predictive control value in consideration of the estimated time of arrival at each bus stop.

The method may further include, after the heat acquisition constant model generation step, repeatedly learning the heat acquisition constant model to remove heat acquisition constant model values out of a tolerance range of the heat acquisition constant model.

The method may further include, after the model-based predictive control step, determining whether a heat acquisition value above a first heat acquisition value preset occurs, wherein if a heat acquisition value above the first heat acquisition value occurs, the passenger heat calculation step and the outside air heat calculation step may be performed again.

The method may further include, after the passenger heat calculation step and the outside air heat calculation step are performed again, determining whether the heat acquisition value above the first heat acquisition value occurs repeatedly at least a certain number of times, wherein if the heat acquisition value above the first heat acquisition value occurs repeatedly at least a certain number of times, the heat acquisition constant model is modified and the model-based predictive control step is performed depending on the modified heat acquisition constant model.

The present disclosure may use a model specifically having learned the heat generated from each passenger and the outside air heat at a specific time, date, and place and perform air conditioning predictive control depending on the model value reflecting the learning results, which does not impair driver alertness and fatigue so as to help safe driving, while reducing air conditioning energy.

### BRIEF DESCRIPTION OF THE DRAWINGS

FIG. 1 illustrates a process for a conventional air conditioning control technique;

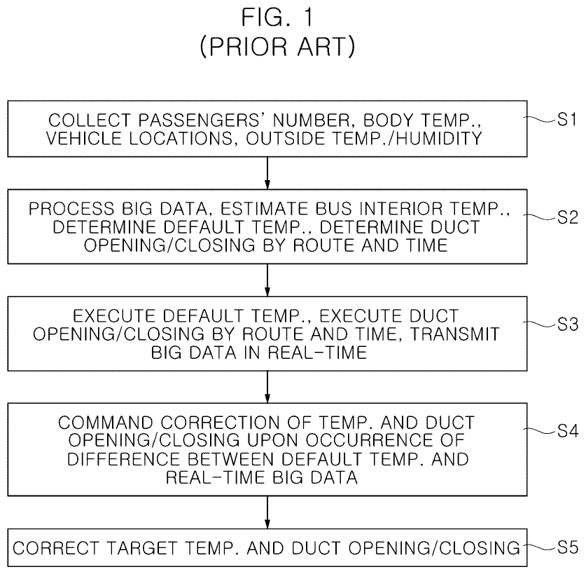

FIG. 2 is a schematic block diagram illustrating a predictive air conditioning control system according to an embodiment of the present disclosure;

FIG. 3 shows example waveforms of vehicle sensor signals according to an embodiment of the present disclosure;

FIG. 4 shows bus route data from a first week Monday utilizing GPS and Open API according to an embodiment of the present disclosure;

FIG. 5 illustrates a heat acquisition constant model obtained using machine learning according to an embodiment of the present disclosure;

FIG. 6 illustrates model-based predictive control using the heat acquisition constant model, compared to real-time control, according to an embodiment of the present disclosure;

FIG. 7 shows the model tolerance range of the heat acquisition constant model according to an embodiment of the present disclosure; and

FIG. 8 illustrates a model learning algorithm according to an embodiment of the present disclosure.

### DESCRIPTION OF SPECIFIC EMBODIMENTS

In order to fully appreciate the purpose, operation, and operational advantages of the present disclosure, reference should be made to the accompanying drawings, which illustrate embodiments of the present disclosure, and to the description thereof.

In describing example embodiments of the present disclosure, any description or repetition of the disclosure that would unnecessarily obscure the essence of the present disclosure is hereby reduced or omitted.

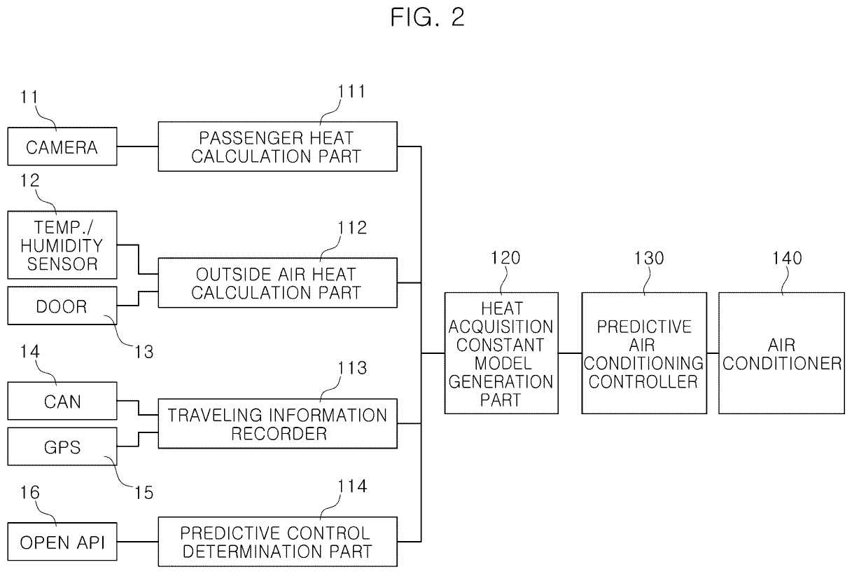

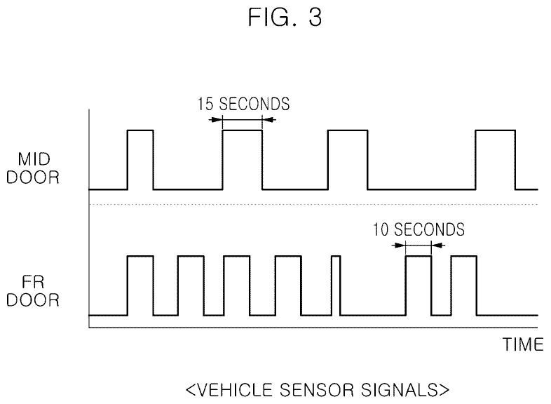

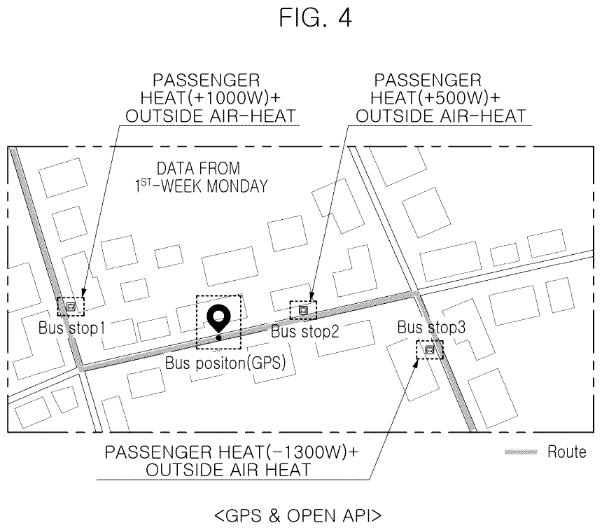

FIG. 2 is a schematic block diagram illustrating a predictive air conditioning control system according to an embodiment of the present disclosure. FIG. 3 shows example waveforms of vehicle sensor signals. FIG. 4 shows bus data from a first week Monday utilizing GPS and Open API.

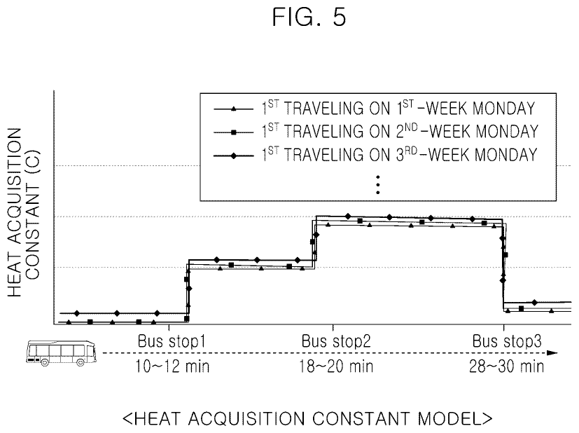

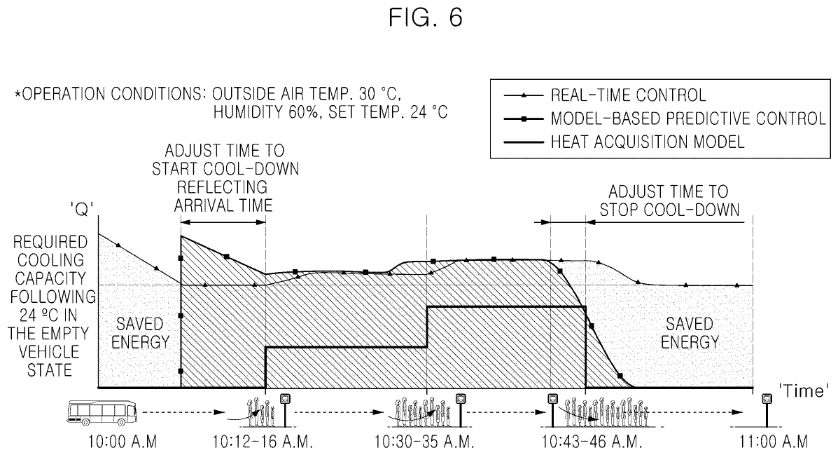

FIG. 5 illustrates a heat acquisition constant model obtained using machine learning, and FIG. 6 illustrates model-based predictive control using the heat acquisition constant model, compared to real-time control.

Hereinafter, a predictive air conditioning control system according to an embodiment of the present disclosure is described with reference to FIGS. 2-6.

As the times change, it is necessary to upgrade the ecosystem of public transportation air conditioning systems that converges with the era of electrification and AI technology such that convergence technologies like AI and machine learning are combined to secure differential user selling proposition (USP) compared to competitors.

Accordingly, the present disclosure is intended to predict acquisition of external heat due to passenger boarding during traveling of a city bus and perform model-based predictive control (MPC) to reduce the operation energy of air conditioning that could be wasted, thereby improving the electric efficiency of public transportation, reducing the driver's distraction during traveling to help safe driving and fatigue reduction, and allowing for application to autonomous buses.

In other words, the present disclosure secures big data during traveling of a city bus (Step 1), generates a heat acquisition constant model of a bus route through AI machine learning (Step 2), and performs predictive air conditioning control based on the heat acquisition constant model.

Target big data to be secured in Step 1 is the number of passengers on the bus, passengers' clothing information, temperature/humidity in the interior of the bus, bus door state, date and time, location of the bus, bus arrival traffic information, and vehicle speed.

The number of passengers on the bus and the passengers' clothing information are collected by interior cameras installed on the bus. The clothing information may be information about the length of the clothing.

The temperature/humidity in the interior of the bus is collected by a temperature/humidity sensor in the interior of the bus.

The door state of the bus includes the open state and open time of the front door for boarding and the middle door for alighting, which is collected through the controller area network (CAN) communication of the vehicle.

The current date and time during traveling may be collected through the CAN communication of the vehicle and recorded on a weekly basis.

The location information of the bus is collected through a GPS sensor, and the bus arrival traffic information is the information about the estimated time of the bus's arrival at a bus stop, which is collected using an open application programming interface (Open API).

In addition, vehicle speed may be collected through the CAN communication of the vehicle.

Through machine learning using the big data collected in this way, the heat acquisition constant model of a bus route is generated.

The generation of the heat acquisition constant model by machine learning may be performed by a predictive air conditioning controller in the bus, which may be a part of the main control unit (MCU).

The number of passengers in the bus during traveling of the bus is counted from the image of a camera 11 in the bus, and heat acquired from passengers is calculated (the number of passengers in the bus x heat acquisition per person) by a passenger heat calculation part 111.

The passengers' clothing information is the information about whether the clothing is short sleeve or long sleeve, which is checked through the image of the camera 11. In the case of short sleeves, the passenger heat calculation part 111 adds the sensible heat caused by the body temperature together with latent heat to be caused by passengers breathing.

In other words, for example, it can be calculated as in the short sleeve example: heat value per person=sensible heat (50 W, body temperature)+latent heat (50 W, breathing). In a long sleeve example it can be calculated as: heat value per person=latent heat (50 W, breathing).

The temperature/humidity in the interior of the bus detected by the temperature/humidity sensor 12 is utilized as a reference (sensible heat acquisition=temperature difference between inside and outside air, latent heat acquisition=humidity difference between inside and outside air) by calculating, by the outside air heat calculation part 112, the heat acquisition by the inflow of outside air.

The outside air heat calculation part 112 calculates the cumulative door opening time signal through the state of the bus door 13, and calculates (the door opening time x the heat acquired by the inflow of outside air) and utilizes the calculated value as a reference.

In other words, as illustrated in FIG. 3, air volume=doorway area×opening time is calculated and utilized as a reference for the heat acquisition.

Next, the traveling information recorder 113 receives the current date and time during traveling of the bus through the CAN signal 14 of the vehicle and utilizes the same as a time and date reference for the change in heat acquired during traveling, and receives the location information of the bus from the GPS 15 and utilizes the same as a bus location reference for the change in heat acquired during traveling.

The predictive control determination part 114 calculates the expected time of arrival of the bus at a bus stop from the bus arrival traffic information through the OPEN API 16 to determine the time to start and stop the predictive air conditioning control, and adjust the operation time during congestion.

The date, time, and location information may be used to generate a route map as illustrated in FIG. 4, which may include the previously calculated heat acquisition and air inflow as illustrated.

The vehicle speed is concerned with heat dissipation, and the higher the vehicle speed, the higher the coefficient of performance (COP), which may be utilized as a reference for RPM adjustment.

The heat acquisition constant model generation part 120 uses the above calculated data to generate a heat acquisition constant model C according to the location (BUS STOP 1, 2, 3, and the like), date, and time through machine learning as illustrated in FIG. 5.

The heat acquisition constant model C is calculated as follows:

C=Heat acquired from passengers (or passenger heat)+Air inflow×k (a variable for real-time acquisition of outside air heat)

The passenger heat is a prediction value based on the number of boarding passengers calculated earlier, and the air inflow is a prediction value based on the door opening.

The variable (k) for real-time acquisition of outside air heat is calculated as sensible heat caused by outside air inflow+latent heat (reflected in real-time as weather changes are difficult to predict).

The heat acquisition constant model also includes information on the location of the bus and the location of the bus stop via GPS, and information on what time and minute the bus usually arrives at and departs from which stop by route time on Monday via bus arrival information through the OPEN API.

The data may also be exchanged between vehicles, so that vehicles on the same route may share heat acquisition constant models with each other.

Next, based on the calculated heat acquisition constant model, the predictive air conditioning controller 130 performs the predictive air conditioning control (model-based predictive control), as illustrated in FIG. 6, to control the air conditioner 140 depending on the predictive air conditioning control value.

As illustrated, the conventional real-time control controls the air conditioning according to the required cooling capacity, for example, following 24° C. in the empty state of the vehicle.

On the other hand, in the model-based predictive control reflecting the heat acquisition constant model according to the present disclosure, it can be seen that energy may be saved compared to the conventional real-time control by starting the operation of the air conditioner at a certain time prior to the arrival time of the first bus stop and stopping the operation of the air conditioner in advance of a certain time prior to the arrival time of the third bus stop, for example.

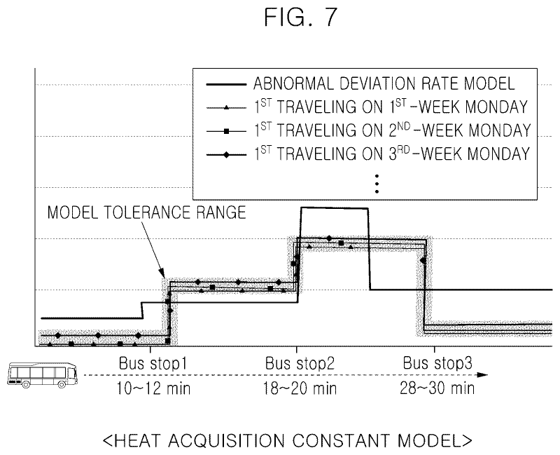

On the other hand, additionally referring to the learning method for generating the heat acquisition constant model with reference to FIG. 7, it is important to secure the prediction accuracy of the model first, so it is desirable to secure an accuracy of 90% (adjustable) or more through iterative learning of the heat acquisition constant.

Therefore, if the constant model deviates from the tolerance range by ±10% (adjustable), the constant model may be considered as dummy data.

In addition, the algorithm for dealing with the deviation rate from the model performs real-time control entry and big data acquisition when the heat acquisition (1,000 w_adjustable) is high enough to affect the predictive control, and otherwise maintains the predictive control.

In addition, in the algorithm for dealing with the deviation rate from the model, if the deviation rate from the model is eliminated, it is monitored on a weekly basis, and if the deviation occurs repeatedly (3 weeks, adjustable), the model is modified and reflected in the predictive control, and if not, it is considered as dummy data and the current predictive control is maintained.

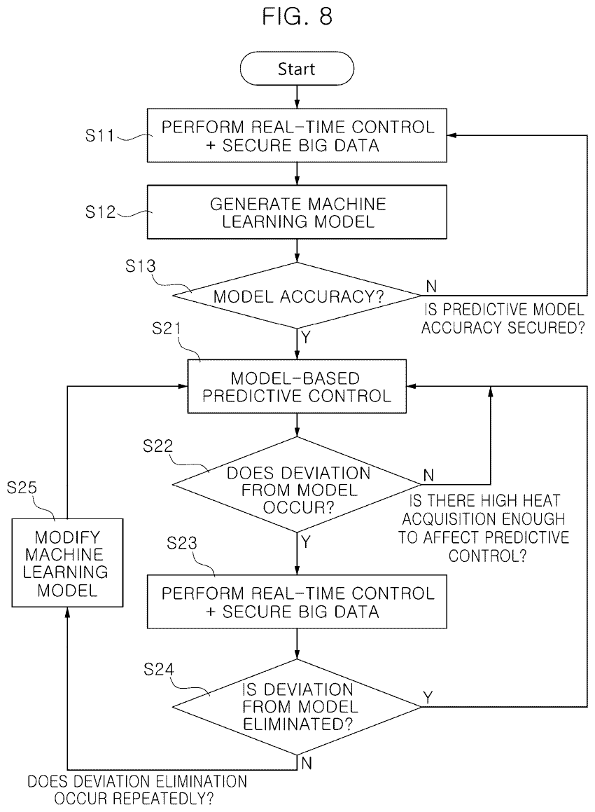

Sequentially referring to the predictive air conditioning control method according to the present disclosure with reference to FIG. 8, first, real-time control is performed according to the control method of the present disclosure, and big data is obtained according to the method described above (S11).

Then, a heat acquisition constant model is generated by AI machine learning using the obtained big data (S12).

Then, the model accuracy is determined (S13). In other words, through iterative learning of the heat acquisition constant, it is determined whether the accuracy of e.g., 90% or more is secured, and if it is determined to be secured, model-based predictive control is performed (S21). If it is determined that the model accuracy is not secured, the process returns to S11 and performs big data acquisition again.

After performing model-based predictive control (S21), it is determined whether there is a deviation from the model (S22). If a heat acquisition value (the first heat acquisition value preset, e.g., 1,000 w) is calculated to be high enough to affect the predictive control, real-time control is initiated and big data is secured again (S23).

However, as a result of determination, if the first heat acquisition value does not occur, the model-based predictive control continues to be performed (S21).

After securing big data in S23, it is determined whether the deviation from the model is eliminated (S24). The occurrence of deviation is determined by whether or not the deviation has occurred more than a certain number of times. If the deviation does not occur repeatedly, it is considered as dummy data, and the model-based predictive control (S21) is maintained.

On the other hand, if the deviation occurs repeatedly more than a certain number of times, it is determined that the deviation has not yet been eliminated, and the machine learning model is modified (S25) and model-based predictive control is performed again (S21).

While the foregoing disclosure has been described with reference to the illustrative drawings, it should be apparent to those of ordinary skill in the art that it is not limited to the embodiments described, and that various modifications and variations may be made without departing from the spirit and scope of the present disclosure. Accordingly, such modifications or variations should be considered as falling within the scope of the claims of the present disclosure, and the claims of the present disclosure should be construed based on the appended claims.

What is claimed is:

1. A predictive air conditioning control system for a bus, the predictive air conditioning control system comprising:
a passenger heat calculation part configured to calculate heat acquired from passengers within the bus;
an outside air heat calculation part configured to calculate heat acquired from an inflow of outside air;
a heat acquisition constant model generation part configured to generate a heat acquisition constant model for a bus route by reflecting the heat acquired from passengers and the heat acquired from the outside air; and
a predictive air conditioning controller configured to generate a model-based predictive control value applied with the heat acquisition constant model and further configured to control an air conditioner of the bus depending on the model-based predictive control value.

2. The predictive air conditioning control system of claim 1, wherein the passenger heat calculation part is configured to calculate the heat acquired from passengers by multiplying a number of passengers counted by a camera mounted on the bus at each bus stop on the bus route and a heat generated from each passenger.

3. The predictive air conditioning control system of claim 2, wherein the passenger heat calculation part is configured to calculate the heat generated from each passenger by receiving clothing information about passengers' clothing detected by the camera and differentially applying the heat generated from each passenger depending on the clothing information.

4. The predictive air conditioning control system of claim 1, wherein the outside air heat calculation part is configured to calculate the heat acquired from outside air, at each bus stop on the bus route, by using a temperature difference between an inside air and an outside air and a humidity difference between the inside air and the outside air sensed by a temperature sensor and a humidity sensor mounted on the bus.

5. The predictive air conditioning control system of claim 4, wherein the outside air heat calculation part calculates a door opening time of the bus from a controller area network (CAN) signal of the bus.

6. The predictive air conditioning control system of claim 5, wherein the heat acquisition constant model generation part is configured to generate the heat acquisition constant model by reflecting the heat generated from each passenger and multiplying the heat acquired from the inflow of outside air by the door opening time.

7. The predictive air conditioning control system of claim 6, further comprising a traveling information recorder configured to receive a current date and time during traveling of the bus by the CAN signal of the bus, and record changes in the heat acquired from passengers and the heat acquired from the inflow of the outside air during traveling.

8. The predictive air conditioning control system of claim 7, wherein the traveling information recorder is configured to receive location information of the bus during traveling by a global positioning system (GPS) mounted on the bus and record changes in the heat acquired from passengers depending on a location of the bus and in the heat acquired from the inflow of the outside air.

9. The predictive air conditioning control system of claim 8, further comprising a predictive control determination part configured to calculate an estimated time of arrival at each bus stop from bus arrival traffic information of the bus via an open application programming interface (API) and determine a control time of the air conditioner with the model-based predictive control value in consideration of the estimated time of arrival at each bus stop.

10. The predictive air conditioning control system of claim 9, wherein the heat acquisition constant model generation part is configured to generate the heat acquisition constant model at a date, time and location during traveling of the bus by the traveling information recorder.

11. The predictive air conditioning control system of claim 10, wherein the predictive air conditioning controller is configured to control the air conditioner at a certain time prior to the arrival time of the bus at a specific bus stop depending on the model-based predictive control value of the specific bus stop.

12. The predictive air conditioning control system of claim 4, wherein the heat acquisition constant model generation part is configured to receive the heat acquisition constant model from other buses on the bus route via inter-bus data communication.

13. A predictive air conditioning control method comprising:
a passenger heat calculation step of calculating heat acquired from passengers on a bus at each bus stop on a bus route;
an outside air heat calculation step of calculating heat acquired from an inflow of outside air at each bus stop;
a heat acquisition constant model generation step of generating a heat acquisition constant model for the bus route by reflecting the heat acquired from passengers and the heat acquired from the inflow of outside air; and
a model-based predictive control step of generating a model-based predictive control value applied with the heat acquisition constant model and controlling an air conditioner depending on the model-based predictive control value.

14. The predictive air conditioning control method of claim 13, wherein the passenger heat calculation step comprises calculating the heat generated from each passenger by multiplying a number of passengers counted by a camera mounted on the bus at each bus stop and a heat generated from each passenger.

15. The predictive air conditioning control method of claim 14, wherein the outside air heat calculation step comprises calculating a door opening time of the bus from a controller area network (CAN) signal of the bus, and wherein the heat acquisition constant model generation step comprises generating the heat acquisition constant model by reflecting the heat generated from each passenger and multiplying the heat acquired from the inflow of outside air by the door opening time.

16. The predictive air conditioning control method of claim 15, wherein the heat acquisition constant model generation step comprises generating the heat acquisition constant model depending on a current date and time during traveling of the bus, received by the CAN signal of the bus, and location information of the bus during traveling, received by a global positioning system (GPS) mounted on the bus.

17. The predictive air conditioning control method of claim 16, wherein the model-based predictive control step comprises calculating an estimated time of arrival at each bus stop from bus arrival traffic information of the bus via an open application programming interface (API) and determining a time to control the air conditioner with the model-based predictive control value in consideration of the estimated time of arrival at each bus stop.

18. The predictive air conditioning control method of claim 13, further comprising: after the heat acquisition constant model generation step, repeatedly learning the heat acquisition constant model to remove heat acquisition constant model values out of a tolerance range of the heat acquisition constant model.

19. The predictive air conditioning control method of claim 13, further comprising: after the model-based predictive control step, determining whether a heat acquisition value above a first heat acquisition value preset occurs, wherein if a heat acquisition value above the first heat acquisition value occurs, the passenger heat calculation step and the outside air heat calculation step are performed again.

20. The predictive air conditioning control method of claim 19, further comprising: after the passenger heat calculation step and the outside air heat calculation step are performed again, determining whether the heat acquisition value above the first heat acquisition value occurs repeatedly at least a certain number of times, wherein if the heat acquisition value above the first heat acquisition value occurs repeatedly at least a certain number of times, the heat acquisition constant model is modified and the model-based predictive control step is performed depending on a modified heat acquisition constant model.
